(19) United States
(12) Patent Application Publication
(10) Pub. No.: US 2005/0072384 A1
(43) Pub. Date: Apr. 7, 2005

(54) Duel fuel selection and blending injectors on internal combustion engines

(76) Inventors: Kreg Hadley, Tyler, TX (US); Amanda Hart, Tyler, TX (US); Myranda Fontenot, Tyler, TX (US); Guy A. Pinson, Grand Saline, TX (US)

Correspondence Address: Winona I.S.D.;Attn: Guy Pinson, P.O. Box 218, Winona, TX, 75792, US

(21) Appl. No.: 10/413,409

(22) Filed: Apr. 14, 2003

(51) Int. Cl. F02B 7/00

(52) U.S. Cl. 123/1 A; 123/577

(57) ABSTRACT

More efficient engines produce about 10% more horsepower per compression ratio number increase. Until now, these engines required premium fuel which costs $0.08-$0.16 per gallon more. Our idea is to use a blend of fuels, where 87-octane gasoline or diesel is the primary fuel used under light loads and 10% ethanol (EtOH)/90% gas or diesel is used under heavy loads. This will reduce fuel costs under light loads and the EtOH/gas or diesel will reduce emissions and prevent toxic chemicals in premium fuels. Fuel blending can also be used in large diesel trucks or off road equipment to bring those engines into compliance with future environmental laws. Our experiments verified a 30% reduction in carbon monoxide. Required use of 10% EtOH/90% gas will reduce lawn mower emissions 30% and result in lower ozone concentrations. Manufacturers have already approved the use of this fuel in their products.

### BACKGROUND OF INVENTION

Until now, engines have been limited to a single primary fuel with octane numbers matched to the engine specifications. Therefore, more efficient engines with higher compression ratios and greater horsepower outputs are limited to use of 92 or 93 octane premium.

### BRIEF SUMMARY OF INVENTION

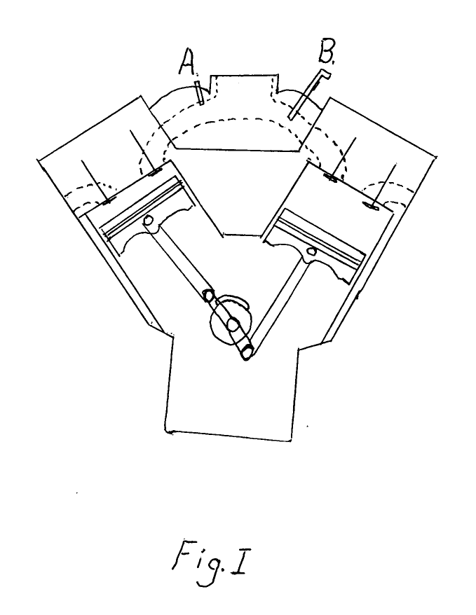

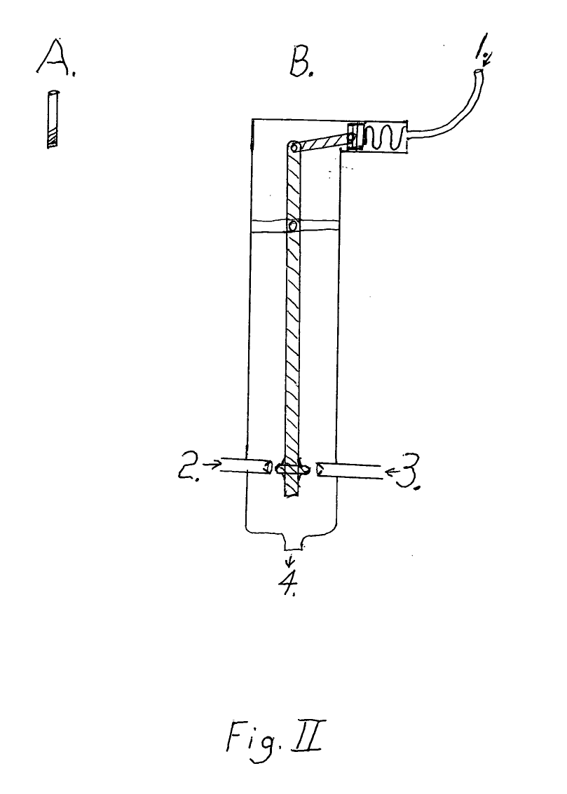

This idea is to allow the use of ethyl alcohol (EtOH)1/87 octane gas (or some other high-octane fuel) at a ratio of 10/90 on auto engines that have been designed to use 89 or 92 octane fueL The engine will be fueled by 87 octane fuel under normal loads of high manifold vacuum and on EtOH/gas fuel under higher loads (passing, up steep grades, etc.) of low manifold vacuum This will be allowed because EtOH octane rating is 106, and adding it will raise the octane rating of the mixture. FIG. 1. details the fuel selection and blending injector.

### DETAILED DESCRIPTION OF INVENTION

This idea is to allow the use of EtOH (or some other high-octane fuel)/87 octane gas at a ration of 10/90 on auto engines that have been designed to use 89 or 92 octane fueL The engine will be fueled by 87-ocaatance fuel under normal loads of high manifold vacuum and on EtOH/gas fuel under higher loads (passing, up steep grades, etc.) of low manifold vacuum. This will be allowed because EtOH octane rating is 106, and adding it will raise the octane rating of the mixture. FIG. 1. details the fuel selection and blending injector.

The dual fuel blending injection will (at high manifold vacuum) close the EtOH/gas fuel inlet to the injector and operate the engine on low 87-octane fuel without pinging. Pinging would damage the engine because this is actually explosions of the fuel instead of even flame front burning. Pinging will result in cylinder pressures of 2100 pSL Under normal operation conditions, we experience pressures of about 700 psi Operations under light loads on 87-octane is allowed because the effective compression ratio is lower. Under low manifolds vacuum (high loads), the 87-octane fuel flow will be reduced or blended to a lower concentration as the vacuum is lowered. At max load only the EtOH/gas blend will be injected into the engine.

### LEGEND FOR FIGS. I. AND II.

Fig. I. Is an internal combustion engine showing the location of vacuum port ‘A’ and fuel-blending valve ‘B’
A. The location of vacuum port on the intake manifold
B. The location of the fuel blending valve to the intake port fuel injection

Fig. II. Is a detailed drawing of the vacuum fitting ‘A’ and fuel blending valve ‘B’
A. The vacuum hose fitting on the intake manifold
B. The fuel blending valve on the port fuel injector
   1. Hose connection point for vacuum hose from port ‘A’ (rubber vacuum hose connects the vacuum port ‘A’ to the fuel blending valve ‘B’ at ‘1’)
   2. ETOH/gas or biodiesel fuel connection to the blending valve (high vacuum closes this line, low vacuum opens this line)
   3. Regular 87 octane gas or diesel connection to the blending valve (low vacuum closes this line, high vacuum opens this line)
   4. Fuel outlet from blending valve to fuel injectors

Alternative procedure is to require fuel-blending valves that are GPS controlled for 18-wheeler diesel trucks. This will allow exclusive biodiesel use within city limits.

1. Lower emissions

2. Lower dependence on foreign oil

3. Renewable fuel

4. Fewer emissions controls on auto

5. Use EtOH/gas in lawn mowers to reduce emissions and city smog

6. Save $0.08/gallon on fuel to consumer
Note: On modified lawn mower 10% EtHO/90% gas will be used at all times for a reduction of 27% emission of smog in cities.
Idea Notebook Reference #1
Apr. 9,2003
